(19) United States
(12) Patent Application Publication
(10) Pub. No.: US 2004/0186914 A1
(43) Pub. Date: Sep. 23, 2004

(54) Data processing circuit

(76) Inventor: Toru Shimada, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/766,358

(22) Filed: Jan. 27, 2004

(30) Foreign Application Priority Data
Mar. 20, 2003 (JP) 2003-078586

(51) Int. Cl. G06F 15/173

(52) U.S. Cl. 709/238

(57) ABSTRACT

In a data processing circuit which sequentially performs a plurality of data processings, data processors assign, to data, processing destination identifiers indicating subsequent processing destinations determined based on information included in the data, and a switch provides the data to the subsequent processing destinations based on the processing destination identifiers. Alternatively, a processing destination identifier assigning portion provides, to the switch, data in which the processing destination identifiers indicating all data processing procedures determined based on the information included in the data are assigned to data, and the switch provides the data to the subsequent processing destination based on the processing destination identifiers, so that the data processors return the data to the switch after performing predetermined processing to the data received from the switch.

### BACKGROUND OF THE INVENTION

1. Field of the Invention

The present invention relates to a data processing circuit, and in particular to a data processing circuit which sequentially performs a plurality of data processings.

In recent years, broadband (high-speed) communication and multimedia traffic have been progressing with developments of communication technology. Since such high-speed multimedia traffic can not be supported by software, a data processing circuit is required, composed of hardware, which sequentially performs a plurality of data processings.

2. Description of the Related Art

For example, a router treating traffic data such as IP data generally mounts thereon a special-purpose hardware such as a module, i.e. a data processing circuit, which takes charge of traffic processing, to realize high-speed data processing.

The data processing circuit generally enhances its throughput by connecting pieces of hardware mutually in series or in parallel. For example, two network processors (hereinafter, occasionally abbreviated as NWP) are mounted in series on the circuit, so that L2 (Layer 2) processing is performed at the first processor, and L3 (Layer 3) processing is performed at the subsequent processor.

The data processing circuit composed of pieces of hardware in this way requires redesigning in order to change circuitry, and has specific problems (1)-(3) as follows:

(1) In order to enhance data processing capacity (throughput performance) by adding hardwares, redesigning of the data processing circuit is required.

(2) Addition/deletion of a traffic data processing function by addition/deletion of hardware is difficult.

(3) The order of pieces of hardware which perform data processing and frequency of data processing can not be changed. Namely, it is difficult to change a processing flow of traffic data.

In order to solve the above-mentioned problem (1), for example, there is a method of preliminarily mounting large amounts of hardware. However, this method is not economical and besides is hard to estimate the number of pieces of hardware to be mounted. When pieces of hardware having different compositions to comply with purposes (functions) are designed, the designing cost becomes high and besides man-hours for developments and tests increase in proportion to the number of its variations, which is not efficient.

Namely, in a traffic data processing circuit with prior art hardwares, the composition can not be easily changed and the redesigning has to be performed.

Also, there is a prior art information processing device (packet processing device) having a plurality of packet processors composed of packet input means which input packets, internal information inheriting means which inherit and control information within the processor as internal information, packet calculation means which perform calculation processing to the inputted packets, and packet output means which output the packets after the calculation, and a communication line for connecting the packet processors in series, in order to perform packet processing.

Namely, among a plurality of packet processings connected in series, the information within the processor is inherited as the internal information, and the calculation processing of packet is performed, thereby deterring overhead and processing the packets at a high speed (see e.g. patent document 1).

Such a packet processing device can be composed by connecting a plurality of packet processors in series with the communication line so that a plurality of processing flows may be performed in a specific order. However, it is impossible for the same packet processing device to perform packet processing, with processing flows changed, e.g. requiring processing flows of different orders and different frequencies.

[Patent Document 1]

Japanese Patent Application Laid-open No. 2002-176440

### SUMMARY OF THE INVENTION

It is accordingly an object of the present invention to provide a data processing circuit which sequentially performs a plurality of data processings, whereby an order of data processings having continuity and directivity can be changed by hardwares, and a kind of data processings can be changed by hardwares.

In order to achieve the above-mentioned object, a data processing circuit according to the present invention comprises: a data processor which performs predetermined processing to data and outputs the data having assigned thereto a processing destination identifier indicating a subsequent processing destination determined based on information included in the data; and a switch which provides the data to the subsequent processing destination based on the processing destination identifier.

FIG. 1 shows a principle arrangement of a data processing circuit 100 according to the present invention. This data processing circuit 100 is provided with data processors (e.g. network processors) 21a and 21b (hereinafter, occasionally represented by a reference numeral 21) and a switch 11.

FIG. 2 includes an operational principle [1] of a data processing circuit according to the present invention. Referring to FIG. 2, the operational principle [1] of the data processing circuit 100 in FIG. 1 will now be described.

Step S01: The data processor 21a performs predetermined processing, e.g. L2 processing to e.g. the inputted data, and outputs data (packet) 80b having assigned thereto a processing destination identifier (ID “54” etc.) indicating subsequent processing determined based on the content of the data, e.g. L3 processing, data output processing (output port), or the like.

It is to be noted that each data processor 21 is supposed to recognize a configuration state or arrangement state of all data processors at this time.

FIG. 3 shows an operational principle of the switch 11, which provides the data (packet) 80b received from the data processor 21a after processing to a terminal (port 54) connected to the data processor 21b which performs subsequent processing to data 82, based on a processing destination identifier 81 (=“54”) assigned to the packet 80b.

Step S02: In the same manner, hereafter, the data processor 21b performs predetermined processing to the data 82 in the packet 80b and returns, to the switch 11, a packet 80c in which the processing destination identifier 81 (=“46”) indicating a subsequent processing destination (in this example, output processing) is reassigned in FIG. 2.

The switch 11 provides the data 82 of the packet 80c to an output port 46 based on the processing destination identifier 81 of the packet 80c.

Thus, it becomes possible for the data processing circuit 100 to easily perform the data processing according to a data processing order determined by the content of the received data. Namely, it becomes possible for the data processing circuit 100 to change a processing order corresponding to the processing content of the data with hardwares.

Also, in the present invention, the predetermined processing may comprise traffic processing. Namely, the predetermined processing may be traffic processing such as L2 processing, L3 processing, Ethernet processing, POS processing, and tunnel processing.

Also, in the present invention, the data processing circuit may further comprise a line interface which provides the switch with the data having assigned thereto a processing destination identifier indicating the data processor that is a first processing destination.

Namely, in FIG. 1, the data processing circuit 100 is further provided with a line interface 14. An operational principle of the present invention will now be described referring to FIG. 2.

Step S03: The line interface 14 provides, to the switch 11, data (packet 80a) in which e.g. a processing destination identifier 81 (=“41”) indicating the first processing destination, i.e. data processor 21a is assigned to traffic data (packet) 80 received.

Thus, the data 80 is provided to the first processing destination, data processor 21a.

Also, in the present invention, the data processing circuit may further comprise a mother board which mounts the switch and a connector which connects the switch and the data processor, and a controller which manages a configuration state of the data processor and notifies the configuration state to the data processor.

Namely, in FIG. 1, the data processing circuit 100 may be further provided with a mother board (not shown) and a controller 12. The mother board mounts e.g. the switch 11 and connectors 15_{—1 and 15}_2. The data processors 21a and 21b which respectively perform e.g. the L2 processing and L3 processing are connected (mounted) to (on) the connectors 15_1 and 15_2.

The controller 12, which may be mounted on e.g. the mother board, manages the configuration state of the data processors 21a and 21b, and notifies the configuration state to the data processors 21a and 21b.

The data processors 21a and 21b determine the processing destination identifier 81 to be assigned to the data processed based on the configuration state.

Thus, it becomes possible for the data processing circuit 100 to easily mount (including addition and deletion) the data processor corresponding to a kind of the processing of the data received and to easily determine the processing procedure.

Also, in the present invention, the data processing circuit may further comprise a memory which preliminarily stores the configuration state of the data processor provided to the controller.

Namely, in FIG. 1, the data processing circuit 100 is provided with a memory 13, which preliminarily stores therein the relationship between the data processor 21a for the L2 processing and the data processor 21b for the L3 processing respectively connected to e.g. the connectors 15_1 and 15_2. Thus, it becomes possible for the controller 12 to recognize the configuration state of the data processors 21a and 21b.

Also, in the present invention, the data processing circuit may further comprise an input portion inputting the configuration state to the memory. Thus, it becomes possible to input the configuration state to the memory from outside. It is to be noted that an input portion is not shown in FIG. 1.

Also, in the present invention, the data processor may have data processing identifier information indicating its data processing content, and the controller may recognize the configuration state by reading the data processing identifier information.

Thus, it becomes possible for the controller 12 to recognize the configuration state without reading the configuration state preset in the memory 13 from outside.

Also, in the present invention, the data processor may have data processing identifier information which indicates its data processing content, and each data processor may mutually exchange data processing identifier information of other data processors.

Thus, it becomes possible for each data processor to recognize the configuration state of all data processors.

Also, in the present invention, the switch may be provided with a queue for temporarily holding data at a preceding stage of an input port or a subsequent stage of an output port.

Namely, a queue is connected to a preceding stage of an input port or the subsequent stage of an output port, which is not shown in FIG. 3. The queue at the preceding stage temporarily holds the inputted data, and the queue at the subsequent stage temporarily holds the data outputted to the output port after switching.

Thus, it becomes possible to synchronize the data processings of e.g. the data processors connected to the preceding stage and the subsequent stage of the switch.

It is to be noted that the queues placed at the preceding stage and the subsequent stage of the switch 11 shown in FIGS. 6A, 6B, 7, 8A, and 8B as will be described later are not shown in FIG. 3 for simplifying the figure.

Also, in order to achieve the above-mentioned object, a data processing circuit according to the present invention comprises: a processing destination identifier assigning portion which assigns, to data, processing destination identifiers indicating all data processing procedures determined by information included in the data; a switch which provides the data to a subsequent processing destination based on the processing destination identifiers, and a data processor which returns the data to the switch after performing predetermined processing to the data received from the switch.

Namely, in FIG. 1, the data processing circuit 100 is provided with a processing destination identifier assigning portion (line interface in FIG. 1) 14, the switch 11, and the data processors 21a and 21b.

FIG. 2 shows an operational principle [2] of the present invention. This operational principle [2] will now be described.

(1) Step S11: The processing destination identifier assigning portion 14 determines all of the data processings performed to the data (packet) 80 and their order based on information included in the data 80 received, and provides, to the switch 11, a packet 80×in which e.g. a processing destination identifier 81_1=“41”, a processing destination identifier 81_2=“54”, and a processing destination identifier 81_3=“47” (hereinafter, a processing destination identifier is occasionally represented by a reference numeral 81) respectively corresponding to the data processors 21a and 21b performing the data processings and the data output processing (output port 47) are assigned to the data 80.

(2) The switch 11 provides the data to the subsequent processing destination based on the processing destination identifier 81.

(3) The data processor 21 performs predetermined processing to the data received from the switch 11, and then returns the data to the switch 11. It is to be noted that while the processors 21a and 21b assign the processing destination identifiers corresponding to the subsequent processing to the packets in FIG. 2, the processors 21a and 21b do not assign the processing destination identifiers in the present invention.

(4) By repeating the above-mentioned (2) and (3), all the processings required for the data 80 are performed.

(5) When the subsequent processing destination is the output processing, the data are outputted from the data processing circuit 100.

Also, in the present invention, the data processor may delete a processing destination identifier indicating its own processor.

Also, in the present invention, the switch may delete a processing destination identifier of the subsequent processing destination.

Also, in the present invention, the data processing circuit may further comprise a mother board which mounts the processing destination identifier assigning portion, the switch, and a connector which connects-the switch and the data processor, and a controller which manages a configuration state of the data processor and notifies the configuration state to the processing destination identifier assigning portion.

Also, in the present invention, the data processor may have data processing identifier information indicating its processing content, and the processing destination identifier assigning portion may read the data processing identifier information.

Namely, in FIG. 1, the processing destination identifier assigning portion (line interface) reads data processing identifier information 93 from the data processors 21a and 21b, thereby enabling the data processing contents and the configuration state of the data processors 21a and 21b to be recognized.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle arrangement of a data processing circuit according to the present invention;

FIG. 2 is a block diagram showing operational principles [1] and [2] of a data processing circuit according to the present invention;

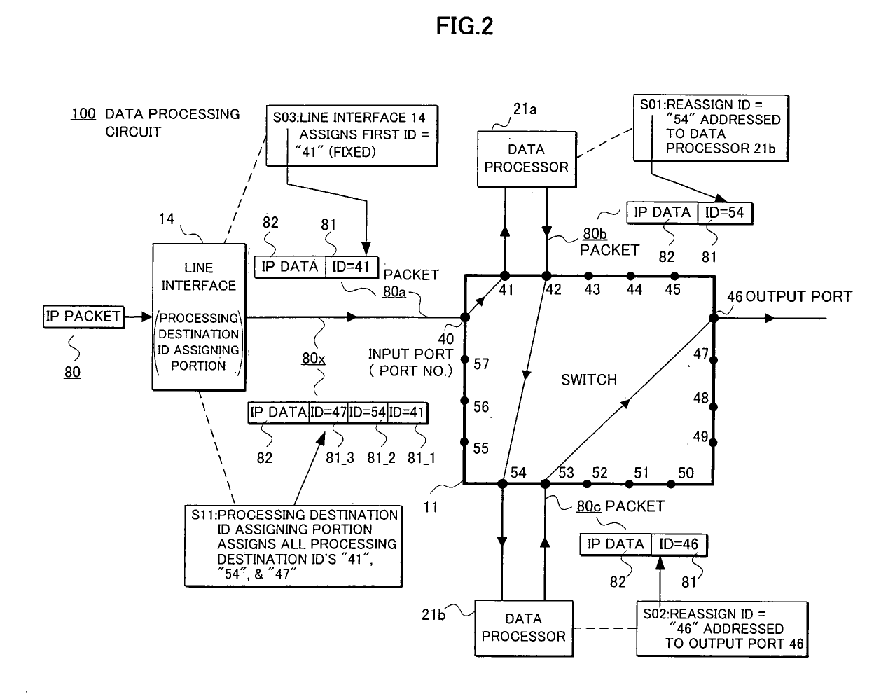

FIG. 3 is a block diagram showing an operational principle of a switch in a data processing circuit according to the present invention;

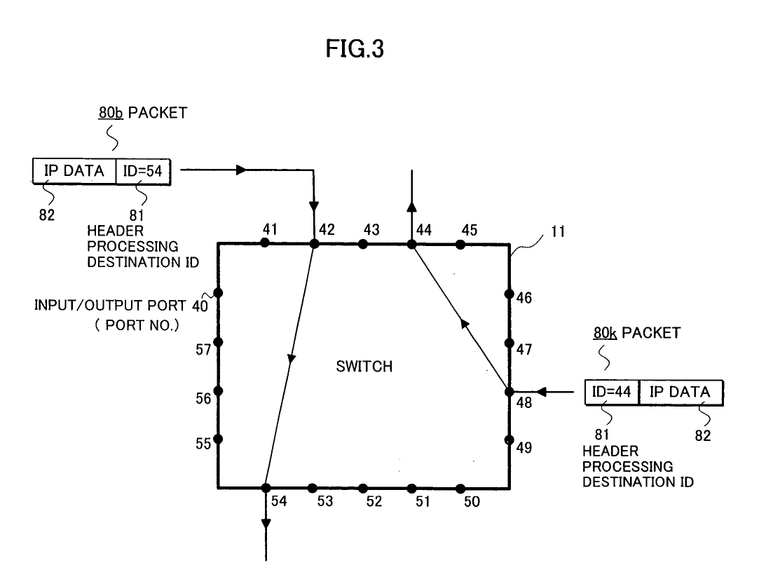

FIGS. 4A and 4B are diagrams showing an embodiment of a data processing circuit according to the present invention;

FIG. 5 is a block diagram showing an embodiment of a data processing circuit according to the present invention;

FIGS. 6A and 6B are block diagrams showing operational embodiments (1) and (2) of a data processing circuit according to the present invention;

FIG. 7 is a block diagram showing an operational embodiment (3) of a data processing circuit according to the present invention; and

FIGS. 8A and 8B are block diagrams showing operational embodiments (4) and (5) of a data processing circuit according to the present invention.

### DESCRIPTION OF THE EMBODIMENTS

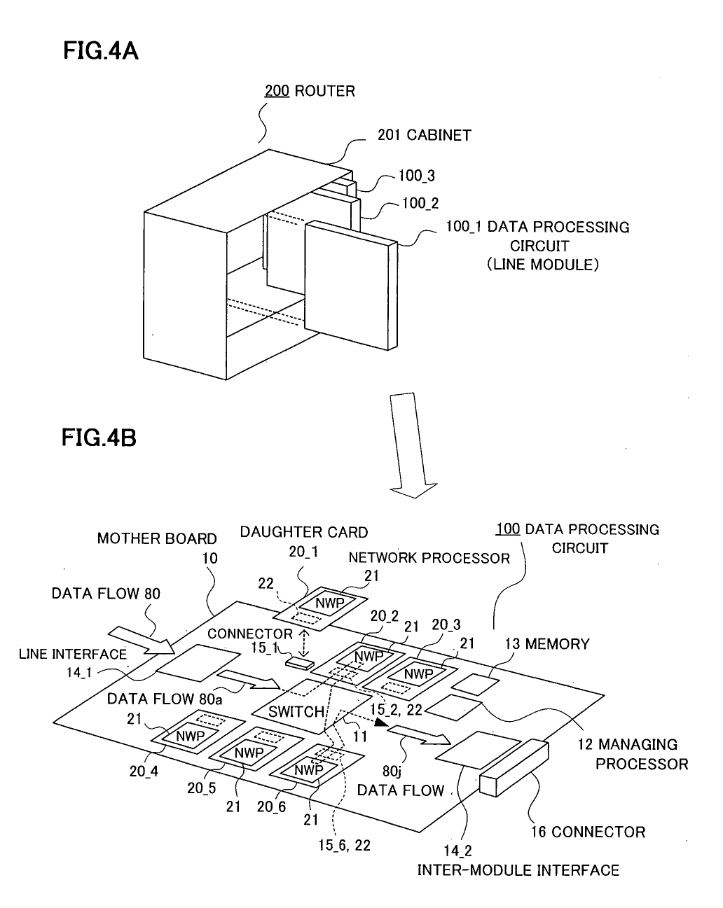

FIG. 4A shows a mounting example applying the data processing circuit 100 according to the present invention to a router 200. This router 200 is composed of data processing circuits 100_1-100_3 (hereinafter, occasionally represented by a reference numeral 100) and a cabinet 201 which accommodates the data processing circuits 100.

FIG. 4B shows a mounting example of the data processing circuit 100, which is composed of a mother board 10 and daughter cards 20_1-20_6 (hereinafter, occasionally represented by a reference numeral 20).

The mother board 10 mounts thereon the switch 11, a managing processor 12, the memory 13, a line interface 14_1 for receiving a data flow 80, connectors 15_1-15_6 (hereinafter, occasionally represented by a reference numeral 15), and a connector 16. This connector 16 is for connecting the data processing circuits 100 and the cabinet.

The daughter card 20 is composed of a network processor 21 and a connector 22. This connector 22 is connected to the connector 15, thereby mutually connecting the daughter card 20 and the mother board 10.

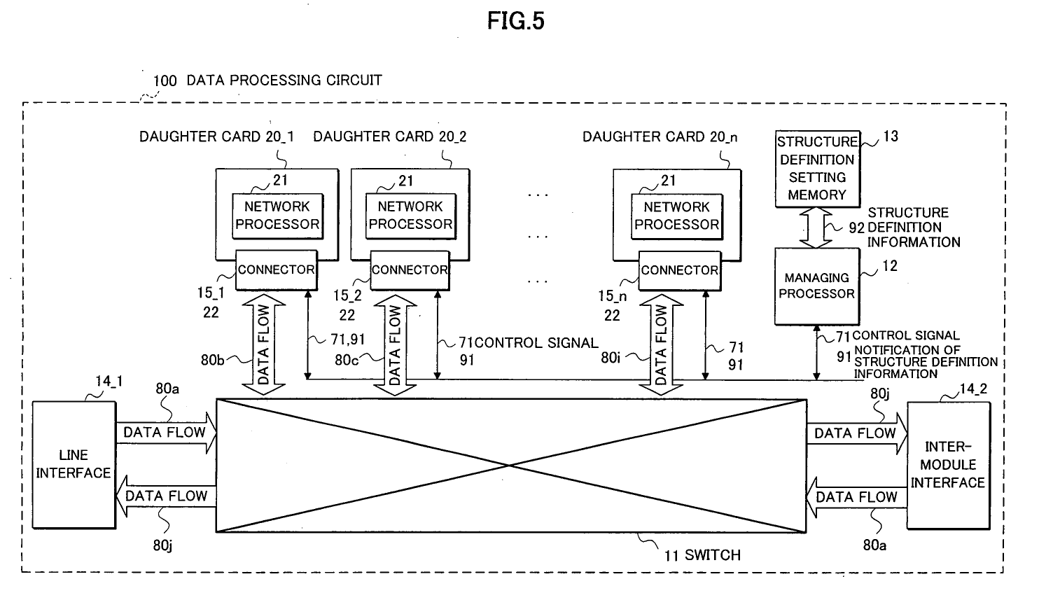

FIG. 5 is an embodiment showing an arrangement of the data processing circuit 100 shown in FIG. 4B. In this embodiment, a full-duplex data processing circuit 100 is shown.

The line interface 14_1 and an inter-module interface 14_2 connected to the connector 16 (not shown, see FIG. 4B) respectively provide a packet (data flow) 80a to the switch 11 and receive a packet (data flow) 80j from the switch 11.

The network processors 21 respectively mounted on the daughter cards 20_1-20_{—}n (hereinafter, occasionally represented by a reference numeral 20) are connected to the switch 11 through the connectors 22 and the connectors 15_1-15_{—}n, and transmit/receive data flows (packets) 80b-80i.

Also, a power supply and a clock supply to the network processors 21, and a transmission/reception of a control signal 71 are performed through the connectors 22 and the connectors 15_1-15_{—}n.

Thus, since the daughter cards 20 are detachable, the number of the network processors 21 mounted is theoretically variable from 1 to “n” at the maximum, if “n” units of connectors 15 are prepared.

In a structure definition setting memory 13, processing contents (e.g. L2 processing, L3 processing, etc.) of the network processors 21 mounted on the daughter cards 20_1-20_{—}n connected to the connectors 15_1-15_{—}n are preset as structure definition information 92 corresponding to the ports of the switch 11.

The managing processor 12 notifies the structure definition information 92 to each of the processors 21 by a notification 91 of structure definition information. Thus, the processors 21 can recognize the processing contents of the processors 21 connected to the ports of the switch 11.

It is to be noted that data processing identifiers indicating respective processing contents may be set in each of the processors 21 instead of the memory 13, and the managing processor 12 may read the data processing identifiers to be notified to the processors 21 as the structure definition information 92.

Also, the processors 21 may mutually notify the data processing identifiers not through the managing processor 12, and may recognize the structure definition information 92.

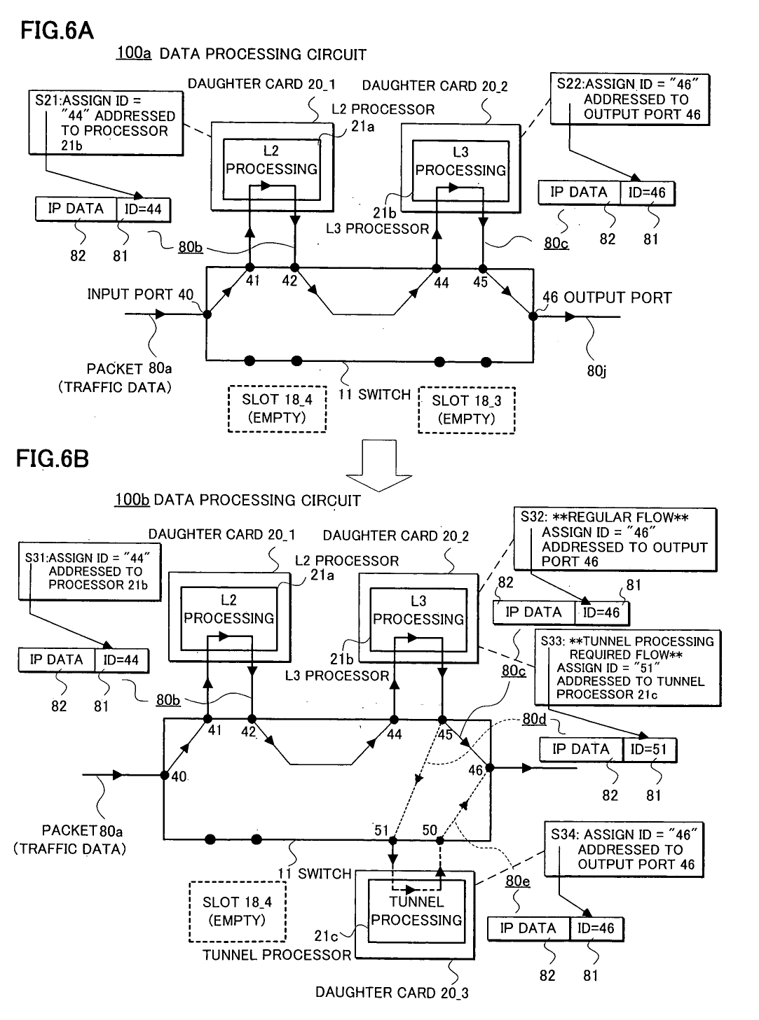

FIG. 6A shows an operational embodiment (1) of a data processing circuit 100a of the present invention. In this embodiment (1), the L2 processor 21a is connected to ports 41 and 42 of the switch 11, and the L3 processor 21b is connected to ports 44 and 45.

The data processing operation of the data processing circuit 100a will now be described.

Step S21: The packet 80a inputted from an input port 40 is provided to the L2 processor 21a through the port 41. The L2 processor 21a performs the L2 processing to the packet 80a and determines that the subsequent processing is L3 processing by referring to an IP data 82 of the packet 80a.

The L2 processor 21a returns, to the switch 11, a packet 80b in which No. “44” of the port 44, to which the L3 processor 21b is connected, namely a processing destination identifier=“44” indicating the L3 processor 21b which subsequently performs the L3 processing, is reassigned in a header 81 of the packet 80a.

The switch 11 transmits the packet 80b to the port 44 based on the processing destination identifier=“44” assigned to the header 81.

Step S22: The L3 processor 21b performs the L3 processing to the packet 80b, and determines that the subsequent processing is output processing by referring to the data 82 of the packet 80b.

The L3 processor 21b returns, to the switch 11, a packet 80c in which No. “46” of an output port 46 is reassigned in the header 81 of the packet 80b.

The switch 11 transmits the packet 80c to the output port 46 based on the processing destination identifier=“46” assigned to the header 81. Thus, the L2 processing and the L3 processing are sequentially performed to the data 82 included in the packet 80a to be outputted.

FIG. 6B shows an operational embodiment (2) of a data processing circuit 100b of the present invention. This embodiment (2) is different from the embodiment (1) shown in FIG. 6A in that a tunnel processor 21c which performs tunnel processing to ports 50 and 51 of the switch 11 is connected to the switch 11.

The data processing operation of the data processing circuit 100b will now be described.

Steps S31 and S32: When the data processing circuit 100b performs the same processing as the data processing circuit 100a of the embodiment (1) to the packet 80a, the same steps as the steps S21 and S22 of the embodiment (1) are performed.

Step S33: When the data processing circuit 100b performs the L2 processing, the L3 processing, and the tunnel processing to the packet 80a, the L3 processor 21b determines that the subsequent processing is the tunnel processing by referring to the data 82 of the packet 80b, and returns, to the switch 11, a packet 80d in which No. “51” of the port 51 to which the tunnel processor 21c is connected is reassigned in the header 81 of the packet 80b.

The switch 11 transmits the packet 80d to the port 51 based on the processing destination identifier=“51” assigned to the header 81.

Step S34: The tunnel processor 21c performs the tunnel processing to the data 82 of the packet 80d, and determines that the subsequent processing is output processing by referring to the data 82 of the packet 80c.

The tunnel processor 21c returns, to the switch 11, a packet 80e in which No. “46” of the output port 46 is reassigned in the header 81 of the packet 80d.

The switch 11 transmits the packet 80e to the output port 46 based on the identifier=“46” assigned to the header 81. Thus, the L2 processing, the L3 processing, and the tunnel processing are sequentially performed to the IP data 82 included in the packet 80a to be outputted.

Thus, by connecting e.g. the tunnel processor 21c to the connector of an empty slot in the data processing circuit 100a which can perform only the L2 processing and the L3 processing of the embodiment (1) shown in FIG. 6A, it can be easily changed to the data processing circuit 100b which can perform the L2 processing, the L3 processing, and the tunnel processing, as shown in FIG. 6B.

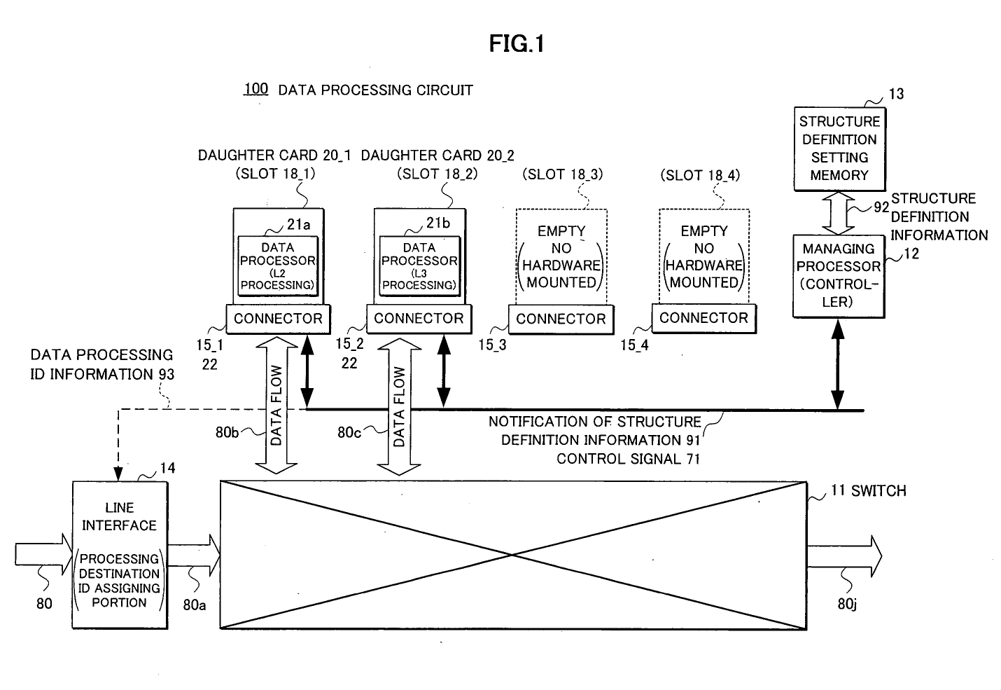

It is to be noted that while each data processor 21 reassigns the subsequent processing destination identifier determined based on the data of the packet received in the header of the packet in the embodiments (1) and (2), a processing destination identifier assigning portion (see FIG. 1) may be provided at a preceding stage of the switch 11, and may add the processing destination identifiers of all data processings to the data as a header based on the received data.

In this case, the data processor 21 performs the data processing to the data provided from e.g. the switch 11, and has only to delete the processing destination identifier designating its own processor 21 and return the data after processing to the switch 11.

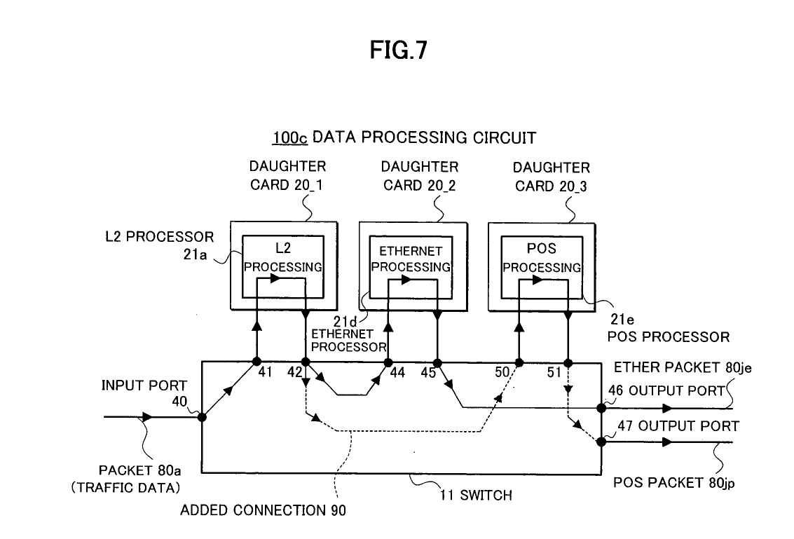

FIG. 7 shows an operational embodiment (3) of a data processing circuit 100c of the present invention. This embodiment (3) is different from the embodiment (1) shown in FIG. 6A in that an Ethernet processor 21d is connected to the ports 44 and 45 instead of the L3 processor 21b, and a POS processor 21e is further connected to the ports 50 and 51.

The L2 processor 21a performs the L2 processing to the packet 80a. When the subsequent processing is found to be the Ethernet processing based on the data of the packet 80a, the L2 processor 21a returns, to the switch 11, the packet in which the processing destination identifier=“44” is reassigned in the header of the packet 80a. When the subsequent processing is determined to be the POS processing, the L2 processor 21a returns, to the switch 11, the packet in which the processing destination identifier=“50” is reassigned.

The Ethernet processor 21d and the POS processor 21e respectively perform the Ethernet processing and the POS processing to the packets, and then return, to the switch 11, the received packets in which the identifiers of the output ports 46 and 47=“46” and “47” are reassigned in the headers of the received packets.

The switch 11 outputs the packets to the output ports 46 and 47 based on the processing destination identifiers 81 set in the headers.

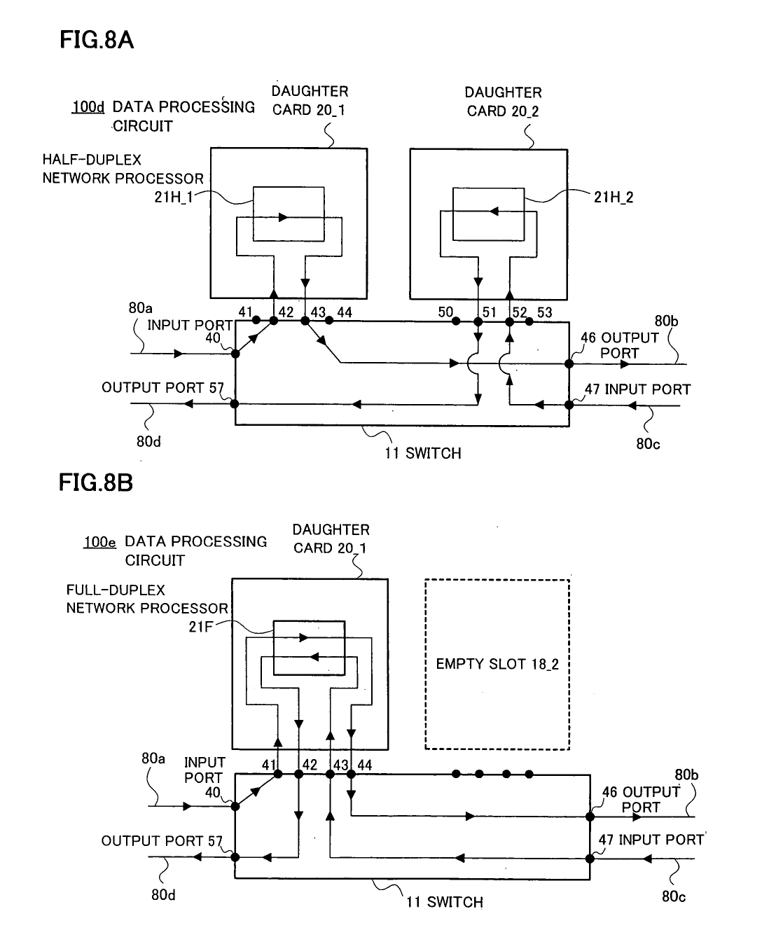

FIG. 8A shows an operational embodiment (4) of a data processing circuit 100d of the present invention. In this embodiment (4), the data processing circuit 100d of duplex transmission is composed by using two half-duplex network processors 21H_1 and 21H_2.

Namely, the network processor 21H_{—}1 which performs e.g. the L2 processing is connected to the ports 42 and 43 of the switch 11, and the network processor 21H_2 which performs the L2 processing is connected to the ports 51 and 52 of the switch 11.

The packet 80a inputted to the input port 40 of the switch 11 is provided to the network processor 21H_1, and outputted from the output port 46 as a packet 80b after the L2 processing is performed thereto.

On the other hand, a packet 80c inputted to the input port 47 of the switch 11 is provided to the network processor 21H_2, and outputted from an output port 57 as a packet 80d after the L2 processing is performed thereto. Thus, the duplex transmission which performs the L2 processing can be realized.

FIG. 8B shows an operational embodiment (5) of a data processing circuit 100e of the present invention. In this embodiment (5), the data processing circuit 100e of the duplex transmission is composed by using a single full-duplex network processor 21F.

Namely, the network processor 21F is connected to the ports 41-44 of the switch 11.

The packet 80a inputted to the port 40 is provided to the network processor 21F through the port 41, and outputted as a packet 80b through the ports 44 and 46 after e.g. the L2 processing is performed thereto at the network processor 21F.

On the other hand, the packet 80c inputted to the port 47 is provided to the network processor 21F through the port 43, and outputted as a packet 80d through ports 42 and 57 after the L2 processing is performed thereto at the network processor 21F.

As described above, a data processing circuit according to the present invention is arranged such that a data processor assigns a processing destination identifier indicating a subsequent processing destination determined based on information included in data, and a switch provides the data to the subsequent processing destination based on the processing destination identifier, alternatively, a processing destination identifier assigning portion assigns, to the data, the processing destination identifiers indicating all data processing procedures determined by the information included in the data, and the switch provides the data to the subsequent processing destination based on the processing destination identifiers, so that the data processor returns the data to the switch after performing predetermined processing to the data received from the switch. Therefore, it becomes possible to change an order of data processings having continuity and directivity with hardwares, and to change a kind of processing by hardware.

Thus, in a hardware module which performs high-speed data traffic processing, following effects (1)-(3) can be expected:

(1) When hardware is added in order to enhance processing capacity (throughput performance), it becomes possible to accommodate the addition without redesigning a module.

(2) By mutually connecting a data processor and a switch with a connector, it becomes possible to easily change a traffic data processing flow.

(3) Since the arrangement of a traffic processing circuit can be easily changed, it becomes possible to flexibly and efficiently accommodate to devices requiring ranging from high performance to low performance, without changing a design of the basic hardware.

What we claim is:

1. A data processing circuit comprising:
a data processor which performs predetermined processing to data and outputs the data having assigned thereto a processing destination identifier indicating a subsequent processing destination determined based on information included in the data; and
a switch which provides the data to the subsequent processing destination based on the processing destination identifier.

2. The data processing circuit as claimed in claim 1 wherein the predetermined processing comprises traffic processing.

3. The data processing circuit as claimed in claim 1, further comprising a line interface which provides the switch with the data having assigned thereto a processing destination identifier indicating the data processor which is a first processing destination.

4. The data processing circuit as claimed in claim 1, further comprising a mother board which mounts the switch and a connector which connects the switch and the data processor, and
a controller which manages a configuration state of the data processor and notifies the configuration state to the data processor.

5. The data processing circuit as claimed in claim 4, further comprising a memory which preliminarily stores the configuration state of the data processor provided to the controller.

6. The data processing circuit as claimed in claim 5, further comprising an input portion inputting the configuration state to the memory.

7. The data processing circuit as claimed in claim 4 wherein the data processor has data processing identifier information indicating its data processing content, and
the controller recognizes the configuration state by reading the data processing identifier information.

8. The data processing circuit as claimed in claim 1 wherein the data processor has data processing identifier information which indicates its data processing content, and
each data processor mutually exchanges data processing identifier information of other data processors.

9. The data processing circuit as claimed in claim 1 wherein the switch is provided with a queue temporarily holding data at a preceding stage of an input port or a subsequent stage of an output port.

10. A data processing circuit comprising:
a processing destination identifier assigning portion which assigns, to data, processing destination identifiers indicating all data processing procedures determined by information included in the data;
a switch which provides the data to a subsequent processing destination based on the processing destination identifiers, and
a data processor which returns the data to the switch after performing predetermined processing to the data received from the switch.

11. The data processing circuit as claimed in claim 10 wherein the data processor deletes a processing destination identifier indicating its own processor.

12. The data processing circuit as claimed in claim 10 wherein the switch deletes a processing destination identifier of the subsequent processing destination.

13. The data processing circuit as claimed in claim 10 wherein the predetermined processing comprises traffic processing.

14. The data processing circuit as claimed in claim 10, further comprising a mother board which mounts the processing destination identifier assigning portion, the switch, and a connector which connects the switch and the data processor, and
a controller which manages a configuration state of the data processor and notifies the configuration state to the processing destination identifier assigning portion.

15. The data processing circuit as claimed in claim 14, further comprising a memory which stores the configuration state of the data processor provided to the controller.

16. The data processing circuit as claimed in claim 15, further comprising an input portion inputting the configuration state to the memory.

17. The data processing circuit as claimed in claim 14 wherein the data processor has data processing identifier information indicating its processing content, and
the processing destination identifier assigning portion reads the data processing identifier information.

18. The data processing circuit as claimed in claim 10 wherein the switch is provided with a queue temporarily holding data at a preceding stage of an input port or a subsequent stage of an output port.
